(19) United States
(12) Patent Application Publication
(10) Pub. No.: US 2004/0107787 A1
(43) Pub. Date: Jun. 10, 2004

(54) Backlash-free rack and pinion

(76) Inventors: Bernard Petrillo, Rye, NY (US); Bruno Israel, Kindkerhook, NY (US)

Correspondence Address: RHODES INSTRUMENT CORPORATION, 11 VIRGINIA ROAD, N. WHITE PLAINS, NY, 10603, US

(21) Appl. No.: 10/065,965

(22) Filed: Dec. 4, 2002

(51) Int. Cl. F16H 55/18; F16H 1/04

(52) U.S. Cl. 74/422; 74/409

(57) ABSTRACT

An improved rack and pinion has been developed that eliminates backlash without using split gears. It is amenable to easy retrofitting of existing systems.

### BACKGROUND OF INVENTION

The rack and pinion drive has established itself as a simple, effective means of accomplishing mechanical translation. However, in the field of small-scale, precision instrumentation it has some obvious deficiencies.

The small physical size of the pinion is not compatible with the implementation of conventional anti-backlash gears. Accurate positioning of the rack can only be accomplished by precise machining of the rack and pinion surfaces. Even after installation of a well-machined system, the effects of normal back and forth motion of the rack will introduce backlash conditions due to inherent wear. Constant adjustment and/or lubrication maintenance is required to maintain the desired level of precision and repeatability.

The need for this long-term accuracy can be appreciated when considering the positioning of stages (tables) for optical analyses with microscopes. These instrument-grade systems incorporate small pinions that negate the use of ordinary split gears to eliminate backlash. Under the typically high magnifications associated with these optical inspections, backlash conditions measured in microns will result in unacceptably large excursions of the viewed scene. Thus, the rack and pinion approach has been relegated to those systems that can either tolerate this mechanical deficiency or are attracted by its lower cost characteristics.

### BRIEF DESCRIPTION OF DRAWINGS

FIG. 1 provides a mechanical depiction of the backlash-free rack and pinion mechanism.

### DETAILED DESCRIPTION

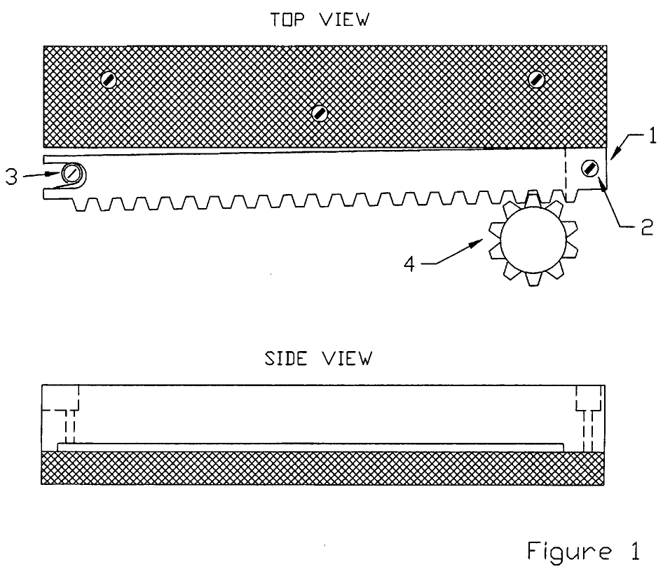

FIG. 1 depicts an embodiment of the invention. The normally fixed rack is replaced with a hinged version 1 that pivots about a shoulder screw 2 at one end of the rack. At the opposite end, a torsion spring 3 applies pressure to the rack to maintain constant contact between the rack and the 4 pinion drive.

1. A rack and pinion system, comprising:
1. a springloaded pivotable rack that eliminates backlash by maintaining constant contact between the the rack and the pinion.
